(19) United States
(12) Patent Application Publication
(10) Pub. No.: US 2023/0081546 A1
(43) Pub. Date: Mar. 16, 2023

(54) METHOD FOR DETERMINING MITOCHONDRIAL EVENTS

(71) Applicant: Stellenbosch University, Stellenbosch (ZA)

(72) Inventors: Benjamin LOOS, Stellenbosch (ZA); Thomas Richard NIESLER, Stellenbosch (ZA); Rensu Petrus THEART, Stellenbosch (ZA)

(73) Assignee: Stellenbosch University, Stellenbosch (ZA)

(21) Appl. No.: 17/759,718

(22) PCT Filed: Feb. 1, 2021
(86) PCT No.: PCT/IB2021/050781

§ 371 Date: Jul. 28, 2022

(30) Foreign Application Priority Data
Jan. 31, 2020 (ZA) 2020/00654

(51) Int. Cl. G06V 20/69; G06V 20/64

(52) U.S. Cl. CPC G06V 20/693; G06V 20/647

(57) ABSTRACT

A method of determining the location and quantity of mitochondrial fission, fusion and depolarisation events that occur in a cell is provided. Using a three-dimensional time lapse image sequence of a cell, the method identifies which of the mitochondria in a cell had depolarised or undergone fission or fusion in the interval between the acquisition of the earlier and later images, indicates the locations of the fission, fusion and depolarisation events, and generates a count of the number of mitochondrial fission, fusion and/or depolarisation events. The method can be used to diagnose a disease or condition associated with mitochondrial dysfunction, such as neurodegenerative disease, cancer or ischaemic heart disease. The method can further be used to screen a compound or composition for use in preventing or treating a disease or condition associated with mitochondrial dysfunction. The method can be computer-implemented, and a computer program product is provided.

### FIELD OF THE INVENTION

The invention relates to a method of determining, in particular localising and/or quantifying, mitochondrial fission, fusion and depolarisation events in a cell.

### BACKGROUND TO THE INVENTION

Mitochondria are highly dynamic organelles that do not operate in a stagnant or isolated manner. Rather, they function in a highly energetic and networked fashion, continuously subjected to rapid remodelling events referred to as fission (fragmentation) and fusion. These events serve as a critical quality control mechanism, not only to adapt and respond to changing metabolic demands but also to enable separation of damaged mitochondria from those in an interconnected state and thereby exposing them to specific degradation. The elimination of damaged mitochondria, mediated through a mitochondrial specific autophagy referred to as mitophagy, decreases the risk of mitochondrial DNA (mtDNA) mutation accumulation. It also improves the electron transport chain (ETC) efficiency. Failure to eliminate damaged mitochondria is a hallmark of neurodegenerative diseases such as Parkinson's disease, while certain heritable diseases, including Charcot-Marie-Tooth Type IIA, are related to dysregulated mitochondrial dynamics. This underscores the important role mitochondrial fission and fusion play, not only in maintaining mitochondrial homeostasis, but also in preserving overall cellular viability. There is therefore a need to quantify these dynamic changes accurately.

Previous attempts to better describe and unravel the interplay between mitochondrial dynamics and cell death onset have largely focused on either the change in the mitochondrial network of the entire cell or the rate at which fission and fusion occurs. However, the accurate description of the quantitative relationship between fission and fusion dynamics in a three-dimensional cellular context, in order to detect deviation from its equilibrium, has remained challenging. Moreover, although it is becoming increasingly clear that intracellular localisation of mitochondria is indicative of regional specific functions, for example the reliance of cellular organelles on mitochondrial ATP provision, it remains largely uncertain where in the mitochondrial network depolarisation is most likely to occur. It therefore remains to be determined which areas of the mitochondrial network are preferentially depolarised to facilitate either transportation or degradation and how these areas relate to the mitochondrial morphometric parameters usually employed.

Current methods typically rely on the manual comparison of two time-lapse image frames in order to observe where fission, fusion or depolarisation occurred. This very labour-intensive approach makes it challenging to gain comprehensive insights into the mitochondrial dynamics of a whole three-dimensional sample. It is usually unclear whether mitochondrial fission and fusion events are changing spatio-temporally, thereby shifting the equilibrium towards either fission or fusion. It is also often not clear whether a cell with a more extensively fused mitochondrial network is in transition or whether it has established a new equilibrium between fission and fusion by means of a newly adapted net contribution of fusion events. Similarly, a cell with greater mitochondrial fragmentation may establish a new equilibrium between fission and fusion as an adaptive response, in order to maintain and preserve this fragmented morphology. Although mitochondrial photoactivation provides a highly selective tool to quantitatively assess mitochondrial dynamics, it does not reveal the relative contribution of fission and fusion events to the observed dynamics. For example, mitochondrial fusion is often enhanced during adaptations to metabolic perturbations, particularly in the perinuclear region, and may protect mitochondria from degradation. On the other hand, a degree of fragmentation is required and desirable to allow, for example, mitochondrial transport in neurons to reach synaptic connections.

There is therefore a need for a method that is able to localise and quantify the number of mitochondrial events in large three-dimensional (3D) time-lapse sample sets, and that also allows quantitative description of the fission/fusion equilibrium as well as the extent of depolarisation.

### SUMMARY OF THE INVENTION

According to a first aspect of the invention, there is provided a method of determining mitochondrial fission, fusion and/or depolarisation events in a cell. Using a three-dimensional time lapse image sequence of a cell, the method identifies which of the mitochondria in a cell had depolarised or undergone fission or fusion in the interval between the acquisition of the earlier and later images

The method may comprise the steps of:
i) acquiring at least two fluorescence-based z-stacks of images of the same cells, wherein the mitochondria are visible in the images and there is a time interval between the acquisition of the first and second z-stacks of images;
ii) binarising the two z-stacks of images to form a binarised z-stack for the first z-stack of images and a binarised z-stack for the second z-stack of images, wherein the mitochondria in the binarised z-stacks are represented by voxel structures;
iii) assigning labels to the voxel structures in the two binarised z-stacks; and
iv) identifying which of the labelled voxel structures may have undergone fission or fusion and/or had depolarised in the interval between the acquisition of the first z-stack of images and the acquisition of the second z-stack of images.

The method may comprise the further step(s) of:
v) determining which of the voxel structures identified in step (iv) had undergone fission or fusion in the interval between the acquisition of the first z-stack of images and the acquisition of the second z-stack of images by filtering out false fission and fusion structure pairs;
vi) indicating the locations of the fission, fusion and/or depolarisation events identified in steps (iv) and/or (v) within the cells; and/or
vii) generating a count of the number of mitochondrial fission, fusion and depolarisation events.

The fluorescence intensity of the two z-stacks of images may be normalised between steps (i) and (ii).

Between steps (iii) and (iv), each of the labelled structures may be separated into an array of z-stacks for each of the binarised z-stacks, where each z-stack in each of the arrays contains only one labelled voxel structure.

A 3D Gaussian filter may be applied to each z-stack in the first array to create a second array of z-stacks for each of the binarised z-stacks.

Voxels not located on the edges of the labelled voxel structures in the first arrays of z-stacks may be removed to create a third array of z-stacks for each of the binarised z-stacks.

The voxel structures which may have undergone fission or fusion may be determined in step (iv) by:
a) identifying voxel structures which overlap between the binarised first z-stack of images and the binarised second z-stack of images;
b) using the information obtained in step (a) to determine, for each z-stack of images, which structures are associated with other structures within the same z-stack of images;
c) identifying the structures that are associated with each other in the first z-stack of images as structures that are likely to undergo fusion; and
d) identifying the structures that are associated with each other in the second z-stack of images as structures that are likely to undergo fission.

Step (a) may be performed by calculating the overlapping volume of each voxel structure in the binarised first z-stack of images and each structure in the binarised second z-stack of images.

In step (b), the information from step (a) may be used to identify labelled structures in the second z-stack of images that are associated with labelled structures in the first z-stack of images and thereby to identify structures that are associated with each other in the first z-stack of images; and to identify labelled structures in the first z-stack of images that are associated with labelled structures in the second z-stack of images, thereby to identify structures that are associated with each other in the second z-stack of images.

The identification in step (iv) of the voxel structures that had undergone depolarisation may be performed by determining that a labelled voxel structure in the binarised z-stack for the first z-stack of images does not have an associated labelled voxel structure in the binarised z-stack for the second z-stack of images.

The filtering out of false fission and fusion structure pairs in step (v) may be performed by:
e) calculating at least one of the following:
   the relative percentage of overlap for the associated structures between the binarised first and second z-stacks of images that were identified in step (a);
   midway points between the associated structures within the same z-stacks of images that were identified in steps (b) and (c); and/or
   distances between the associated structures within the same z-stacks of images that were identified in steps (b) and (c); and
f) removing associated structure pairs for which the relative percentage of overlap is below a predetermined threshold, where the distance between the associated structures is greater than a predetermined threshold, and/or where the midway point between the structures contains a mitochondrial structure in the first binarised z-stack.

The locations of the fission, fusion and/or depolarisation events within the cell may be indicated in step (vi) by generating an output z-stack of images which shows the location of the fission, fusion and/or depolarisation events that occurred in the interval between the acquisition of the first z-stack of images and the acquisition of the second z-stack of images.

More particularly, the method may comprise the steps of:
i) acquiring at least two fluorescence-based z-stacks of images of the same cells, wherein the mitochondria are visible in the images and there is a time interval between the acquisition of the first and second z-stacks of images;
ia) optionally normalising the fluorescence intensity of the two z-stacks of images;
ii) binarising the two normalised z-stacks of images to form a binarised z-stack for the first z-stack of images (B₁) and a binarised z-stack for the second z-stack of images (B₂), wherein the mitochondria in the binarised z-stacks are represented by voxel structures;
iii) assigning labels to the voxel structures in the two binarised z-stacks;
iiia) optionally separating each of the labelled structures into a first array of z-stacks (Lₐᵣ) for each of the binarised z-stacks, where each z-stack in each of the arrays contains only one labelled voxel structure;
iiib) optionally applying a 3D Gaussian filter to each z-stack in the first array (Lₐᵣ) to create a second array of z-stacks (Gₐᵣ) for each of the binarised z-stacks;
iiic) optionally removing voxels not located on the edges of the labelled voxel structures in the first arrays of z-stacks (Lₐᵣ) to create a third array of z-stacks (Eₐᵣ) for each of the binarised z-stacks;
iv) identifying which of the labelled voxel structures may have undergone fission or fusion and/or had depolarised in the interval between the acquisition of the first z-stack of images and the acquisition of the second z-stack of images;
v) optionally determining which of the voxel structures identified in step (iv) had undergone fission or fusion in the interval between the acquisition of the first z-stack of images and the acquisition of the second z-stack of images by filtering out false fission and fusion structure pairs;
vi) optionally indicating the locations of the fission, fusion and/or depolarisation events identified in steps (iv) and (v) within the cells;
vii) optionally generating a count of the number of mitochondrial fission, fusion and/or depolarisation events.

Even more particularly, the method may comprise the steps of:
i) acquiring at least two fluorescence-based z-stacks of images of the same cells, wherein the mitochondria are visible in the images and there is a time interval between the acquisition of the first and second z-stacks of images;
ia) normalising the fluorescence intensity of the two z-stacks of images;
ii) binarising the two normalised z-stacks of images to form a binarised z-stack for the first z-stack of images (B₁) and a binarised z-stack for the second z-stack of images (B₂), wherein the mitochondria in the binarised z-stacks are represented by voxel structures;
iii) assigning labels to the voxel structures in the two binarised z-stacks;
iiia) separating each of the labelled structures into a first array of z-stacks (Lₐᵣ) for each of the binarised z-stacks, where each z-stack in each of the arrays contains only one labelled voxel structure;
iiib) applying a 3D Gaussian filter to each z-stack in the first array (Lₐᵣ) to create a second array of z-stacks (Gₐᵣ) for each of the binarised z-stacks;
iiic) removing voxels not located on the edges of the labelled voxel structures in the first arrays of z-stacks (Lₐᵣ) to create a third array of z-stacks (Eₐᵣ) for each of the binarised z-stacks;
iv) identifying which of the labelled voxel structures may have undergone fission or fusion and/or had depolarised in the interval between the acquisition of the first z-stack of images and the acquisition of the second z-stack of images;
v) determining which of the voxel structures identified in step (iv) had undergone fission or fusion in the interval between the acquisition of the first z-stack of images and the acquisition of the second z-stack of images by filtering out false fission and fusion structure pairs;
vi) indicating the locations of the fission, fusion and/or depolarisation events identified in steps (iv) and (v) within the cells; and
vii) generating a count of the number of mitochondrial fission, fusion and/or depolarisation events.

The time interval between the acquisition of the first z-stack of images and the acquisition of the second z-stack of images may be in the range of from about 1 s to about 90 s, and more preferably in the range of from about 5 s to about 60 s.

The images may be micrographs.

The cell may be stained for mitochondria prior to acquisition of the z-stacks of images.

The cell may be from a human or animal subject.

A computer may be used to implement the method or a part thereof.

According to a further aspect of the invention, there is provided a method of diagnosing a disease or disorder which is associated with an increase or decrease in mitochondrial fission, fusion and/or depolarisation events relative to a healthy state, the method comprising determining the location and/or quantity of mitochondrial fission, fusion and/or depolarisation events as described above, and comparing these events to predetermined reference mitochondrial fission, fusion and/or depolarisation events of a healthy or diseased state.

According to a further aspect of the invention, there is provided a method of screening a compound or composition for its potential use in the treatment or prevention of a disease or disorder which is associated with an increase or decrease in mitochondrial fission, fusion and/or depolarisation events relative to a healthy state, the method comprising contacting a human or animal cell with the compound or composition, determining the location and quantity of mitochondrial fission, fusion and/or depolarisation events in a cell as described above, and comparing these to predetermined reference mitochondrial fission, fusion and depolarisation events of a healthy or diseased state.

The disease or disorder may be a neurodegenerative disease, cancer or ischaemic heart disease.

According to further aspects of the invention, there are provided computer-implemented methods of the methods described above.

According to a further aspect of the invention, there is provided a computer program product configured to perform any of the methods described above, the computer program product comprising a computer-readable medium having stored computer-readable program code for performing the steps of the method(s) described above.

### BRIEF DESCRIPTION OF THE FIGURES

The patent application file contains at least one drawing executed in color. Copies of this patent application publication with the color drawings will be provided by the Office upon request and payment of the necessary fee.

FIG. 1 is a flow diagram of an embodiment of a method of determining mitochondrial fission, fusion and/or depolarisation events in a cell in accordance with the present invention;

FIG. 2 is a flow diagram of another embodiment of a method of determining mitochondrial fission, fusion and/or depolarisation events in a cell in accordance with the present invention;

FIG. 3 is a flow diagram of the embodiment of FIG. 1 which further includes a step of determining the location and quantity of mitochondrial fission, fusion and/or depolarisation events in a cell in accordance with the present invention;

FIG. 4 is a flow diagram of an embodiment of a method of diagnosing a disease or condition in accordance with the present invention;

FIG. 5 is a flow diagram of an embodiment of a method of screening a compound or composition for its use in preventing or treating a disease or condition in accordance with the present invention;

FIG. 6 is a flow diagram of image pre-processing steps in an embodiment of the present invention. Image pre-processing begins by choosing two frames from the input time-lapse sequence, Frame 1 and Frame 2. Normalisation, binarisation, and labelling are then performed on both frames. The labelled frames are each separated into an array of z-stacks, where each stack contains only a single labelled structure. Each of the stacks in the array of binarised stacks, for both Frames 1 and 2, is then Gaussian blurred and Canny filtered. The latter contains only the edges of the labelled structures (internal voxels have been removed). The stacks that are used during the automatic image analysis step are labelled in green for Frame 1 and orange for Frame 2. Finally, an array containing the centre of mass for each labelled structure is shown in blue.

FIG. 7 is a flow diagram of automatic image analysis steps in an embodiment of the present invention (the automatic image analysis steps follow on from the image pre-processing step). Automatic image analysis begins by calculating the overlapping volume of each structure in Frame 1 with each structure in Frame 2. V_{xy} refers to the number of voxels that overlap between structure x in Frame 1 and structure y in Frame 2. To compensate for such coincidental matches, all overlapping volumes that account for less than 1% of the volume of either structure in question are eliminated. Label 0 refers to the background. Using matrix V, the labelled structures that are associated with each other both between Frames 1 and 2, as well as within the same frame, can be calculated. The relationships are encoded as arrays of lists, where each list is related to the labelled structure corresponding to the array index. Therefore, the 8^{th} list in the array relates to labelled structure number 8. F 2L₈ refers to label number 8 in Frame 2 that is associated with the structure at the array index. Next, the relative percentage of overlap (e.g. %_{F 2L8}) is calculated for the associated structures between the frames, and is interpreted in conjunction with A₁ and A₂. The midway points (e.g. p₄) and distances (e.g. d₄) between two structures within the same frame are calculated, and are interpreted in conjunction with W₁ and W₂. Using these arrays of lists, the status (e.g. S_{F 1L4}) of fission, fusion, depolarisation or no event can be determined for each mitochondrial structure. Finally, the event can be overlaid on the original z-stack at the location of the midway points.

FIG. 8 shows a back-and-forth structure matching algorithm used to determine mitochondrial structures that are candidates for fission and fusion.

FIG. 9 shows the experimental results for Control sample 1. A. Maximum intensity projection (MIP) of the mitochondrial events overlaid on the entire sample image of every fourth frame in the time-lapse sequence. B. A region of interest (ROI) selection, indicated by the white square in column A. Frame 1 matches the time indicated, Frame 2 shows the subsequent time step, MEL shows the detected mitochondrial events overlaid on Frame 1. C. A selection of the ROI frames in column B, visualised in 3D using volume rendering. D. The five-frame simple moving average of the values calculated by the method of the invention. For the number of events, the area plots indicate the maximum and the minimum that MEL detected for different pre-processing parameters.

FIG. 10 shows the experimental results for Control sample 2. A-D are as per FIG. 9.

FIG. 11 shows the experimental results for HCQ treated sample 1. A-D are as per FIG. 9.

FIG. 12 shows the experimental results for HCQ treated sample 2. A-D are as per FIG. 9.

FIG. 13 shows 3D visualisation of MEL events showing the first frame in the time-lapse sequence in for the FIGS. 8-11. A. Control sample 1. B. Control sample 2. C. HCQ treated sample 1. D. HCQ treated sample 2.

FIG. 14 shows a process flow for the method of the invention using a synthetic image as an example.

FIG. 15 shows the calculated matrix and array lists for the example of FIG. 14.

FIG. 16 shows the determination of fission and fusion event locations for the example of FIGS. 14 and 15.

### DETAILED DESCRIPTION OF THE INVENTION

A method of determining the location and quantity of mitochondrial fission, fusion and depolarisation events that occur in a cell is described herein. Using a three-dimensional time lapse image sequence of a cell, the method can identify which of the mitochondria in a cell have depolarised or undergone fission or fusion in the interval between the acquisition of the earlier and later images; can indicate the locations of the fission, fusion and/or depolarisation events; and can generate a count of the number of mitochondrial fission, fusion and/or depolarisation events. The method can be used to diagnose a disease or condition associated with an increase or decrease in mitochondrial fission, fusion and depolarisation events. The method can also be used to screen a compound or composition for use in preventing or treating a disease or condition associated with an increase or decrease in mitochondrial fission, fusion and/or depolarisation events. Some or all of the steps of the method can be computer-implemented, and a computer program product configured to perform the method is also provided.

Throughout the specification, the term “binarise” is intended to refer to a process of taking a grayscale image, where each pixel stores a value in some range (such as 0 to 255), and converting it to a black and white, or true and false, representation where most commonly the structure of interest is white (true) and the background is black (false).

The word “comprise” or variations such as “comprises” or “comprising” is understood to imply the inclusion of a stated integer or group of integers but not the exclusion of any other integer or group of integers.

The term “depolarisation” refers to the loss of the mitochondrial voltage gradient.

The term “Gaussian filter” refers to a filter whose impulse response is a Gaussian function (or an approximation to it). In the context of image processing this is also sometimes referred to as Gaussian blur, since it is usually used to blur the image or to reduce noise.

The term “normalise” is intended to refer to a process of changing the range of pixel intensity values in such a way to improve the consistency of the image quality and pixel intensity histogram between various images of different samples.

The term “voxel structure” refers to an array of contiguous discrete elements into which a representation of a three-dimensional object is divided. Each discrete element within the array is a “voxel”.

“Z-stacking” (also known as focus stacking) is a digital image processing method which combines multiple images taken at different focal distances to provide a composite image with a greater depth of field (i.e. the thickness of the plane of focus) than any of the individual source images. Consequently, a z-stack is a composite image formed from multiple images (e.g. micrographs) taken at different focal distances.

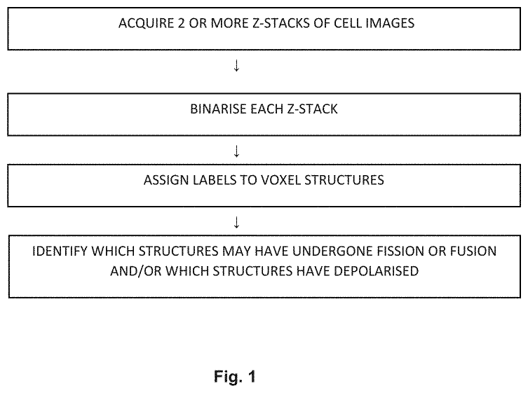

The method includes the steps of:
i) acquiring at least two fluorescence-based z-stacks of images of the same cells, wherein the mitochondria are visible in the images and there is a time interval between the acquisition of the first and second z-stacks of images;
ii) binarising the two z-stacks of images to form a binarised z-stack for the first z-stack of images and a binarised z-stack for the second z-stack of images, wherein the mitochondria in the binarised z-stacks are represented by voxel structures;
iii) assigning labels to the voxel structures in the two binarised z-stacks; and
iv) identifying which of the labelled voxel structures may have undergone fission or fusion and/or had depolarised in the interval between the acquisition of the first z-stack of images and the acquisition of the second z-stack of images.
   This is shown in FIG. 1.

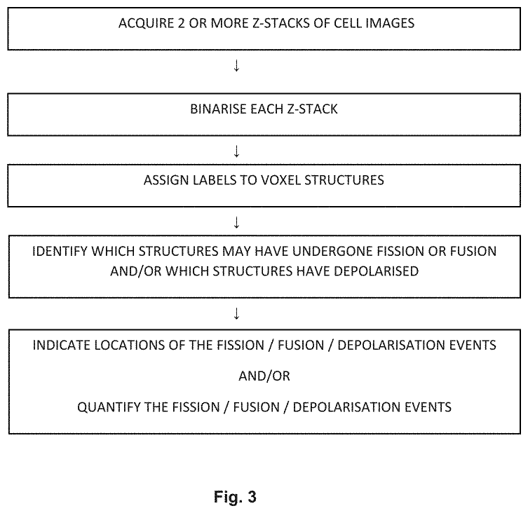

The method can also include one or more of the following steps, a shown in FIG. 3:
v) determining which of the voxel structures identified in step (iv) had undergone fission or fusion in the interval between the acquisition of the first z-stack of images and the acquisition of the second z-stack of images by filtering out false fission and fusion structure pairs;
vi) indicating the locations of the fission, fusion and/or depolarisation events identified in steps (iv) and/or (v) within the cells; and/or
vii) generating a count of the number of mitochondrial fission, fusion and depolarisation events.

The fluorescence intensity of the two z-stacks of images can optionally be normalised between steps (i) and (ii).

Between steps (iii) and (iv), each of the labelled structures can optionally be separated into an array of z-stacks for each of the binarised z-stacks, where each z-stack in each of the arrays contains only one labelled voxel structure. A 3D Gaussian filter can optionally be applied to each z-stack in the first array to create a second array of z-stacks for each of the binarised z-stacks.

Voxels not located on the edges of the labelled voxel structures in the first arrays of z-stacks can optionally be removed to create a third array of z-stacks for each of the binarised z-stacks.

The voxel structures which may have undergone fission or fusion can optionally be determined in step (iv) by:
a) identifying voxel structures which overlap between the binarised first z-stack of images and the binarised second z-stack of images;
b) using the information obtained in step (a) to determine, for each z-stack of images, which structures are associated with other structures within the same z-stack of images;
c) identifying the structures that are associated with each other in the first z-stack of images as structures that are likely to undergo fusion; and
d) identifying the structures that are associated with each other in the second z-stack of images as structures that are likely to undergo fission.

Step (a) can optionally be performed by calculating the overlapping volume of each voxel structure in the binarised first z-stack of images and each structure in the binarised second z-stack of images.

In step (b), the information from step (a) can optionally be used to identify labelled structures in the second z-stack of images that are associated with labelled structures in the first z-stack of images and thereby to identify structures that are associated with each other in the first z-stack of images; and to identify labelled structures in the first z-stack of images that are associated with labelled structures in the second z-stack of images, thereby to identify structures that are associated with each other in the second z-stack of images.

The identification in step (iv) of the voxel structures that had undergone depolarisation can optionally be performed by determining that a labelled voxel structure in the binarised z-stack for the first z-stack of images does not have an associated labelled voxel structure in the binarised z-stack for the second z-stack of images.

The filtering out of false fission and fusion structure pairs in step (v) can optionally be performed by:
e) calculating at least one of the following:
   the relative percentage of overlap for the associated structures between the binarised first and second z-stacks of images that were identified in step (a);
   midway points between the associated structures within the same z-stacks of images that were identified in steps (b) and (c); and/or
   distances between the associated structures within the same z-stacks of images that were identified in steps (b) and (c); and
f) removing associated structure pairs for which the relative percentage of overlap is below a predetermined threshold, where the distance between the associated structures is greater than a predetermined threshold, and/or where the midway point between the structures contains a mitochondrial structure in the first binarised z-stack.

The locations of the fission, fusion and/or depolarisation events within the cell can optionally be indicated in step (vi) by generating an output z-stack of images which shows the location of the fission, fusion and/or depolarisation events that occurred in the interval between the acquisition of the first z-stack of images and the acquisition of the second z-stack of images.

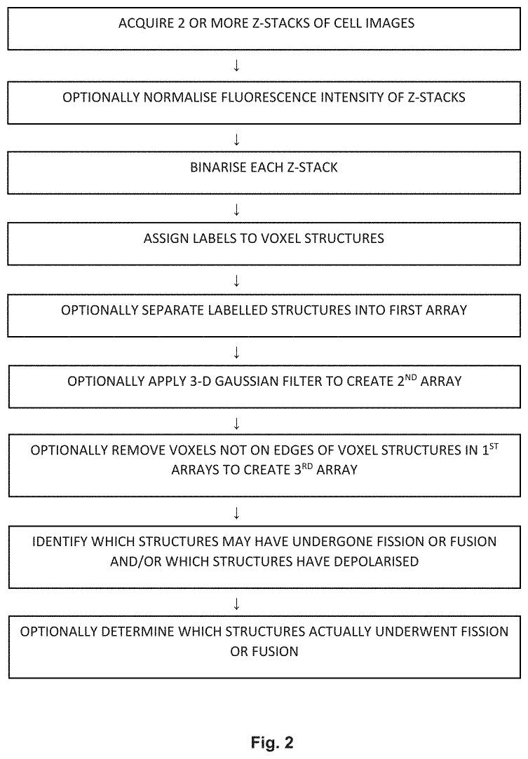

In one embodiment (shown in FIG. 2), the method comprises the steps of:
i) acquiring at least two fluorescence-based z-stacks of images of the same cells, wherein the mitochondria are visible in the images and there is a time interval between the acquisition of the first and second z-stacks of images;
ia) optionally normalising the fluorescence intensity of the two z-stacks of images;
ii) binarising the two normalised z-stacks of images to form a binarised z-stack for the first z-stack of images (B₁) and a binarised z-stack for the second z-stack of images (B₂), wherein the mitochondria in the binarised z-stacks are represented by voxel structures;
iii) assigning labels to the voxel structures in the two binarised z-stacks;
iiia) optionally separating each of the labelled structures into a first array of z-stacks (Lₐᵣ) for each of the binarised z-stacks, where each z-stack in each of the arrays contains only one labelled voxel structure;
iiib) optionally applying a 3D Gaussian filter to each z-stack in the first array (Lₐᵣ) to create a second array of z-stacks (Gₐᵣ) for each of the binarised z-stacks;
iiic) optionally removing voxels not located on the edges of the labelled voxel structures in the first arrays of z-stacks (Lₐᵣ) to create a third array of z-stacks (Eₐᵣ) for each of the binarised z-stacks;
iv) identifying which of the labelled voxel structures may have undergone fission or fusion and/or had depolarised in the interval between the acquisition of the first z-stack of images and the acquisition of the second z-stack of images;
v) optionally determining which of the voxel structures identified in step (iv) had undergone fission or fusion in the interval between the acquisition of the first z-stack of images and the acquisition of the second z-stack of images by filtering out false fission and fusion structure pairs;
vi) optionally indicating the locations of the fission, fusion and/or depolarisation events identified in steps (iv) and (v) within the cells;
vii) optionally generating a count of the number of mitochondrial fission, fusion and/or depolarisation events.

In another embodiment, the method comprises the steps of:
i) acquiring at least two fluorescence-based z-stacks of images of the same cells, wherein the mitochondria are visible in the images and there is a time interval between the acquisition of the first and second z-stacks of images;
ia) normalising the fluorescence intensity of the two z-stacks of images;
ii) binarising the two normalised z-stacks of images to form a binarised z-stack for the first z-stack of images (B₁) and a binarised z-stack for the second z-stack of images (B₂), wherein the mitochondria in the binarised z-stacks are represented by voxel structures;
iii) assigning labels to the voxel structures in the two binarised z-stacks;
iiia) separating each of the labelled structures into a first array of z-stacks (Lₐᵣ) for each of the binarised z-stacks, where each z-stack in each of the arrays contains only one labelled voxel structure;
iiib) applying a 3D Gaussian filter to each z-stack in the first array (Lₐᵣ) to create a second array of z-stacks (Gₐᵣ) for each of the binarised z-stacks;
iiic) removing voxels not located on the edges of the labelled voxel structures in the first arrays of z-stacks (Lₐᵣ) to create a third array of z-stacks (Eₐᵣ) for each of the binarised z-stacks;
iv) identifying which of the labelled voxel structures may have undergone fission or fusion and/or had depolarised in the interval between the acquisition of the first z-stack of images and the acquisition of the second z-stack of images;
v) determining which of the voxel structures identified in step (iv) had undergone fission or fusion in the interval between the acquisition of the first z-stack of images and the acquisition of the second z-stack of images by filtering out false fission and fusion structure pairs;
vi) indicating the locations of the fission, fusion and/or depolarisation events identified in steps (iv) and (v) within the cells; and
vii) generating a count of the number of mitochondrial fission, fusion and/or depolarisation events.

The time interval between the acquisition of the first z-stack of images and the acquisition of the second z-stack of images may be in the range of from about 1 s to about 90 s, and more preferably in the range of from about 5 s to about 60 s, from about 5 s to about 40 s, or from about 5 s to about 20 s.

When implemented by a computer, step (i) of the above method does not need to be performed on the computer. Instead, the z-stack images can be uploaded, downloaded or otherwise acquired by the computer. Similarly, the computer program product need not be configured to perform this step.

The method automatically localises the mitochondrial events occurring between two micrograph frames in a time-lapse sequence. The number of mitochondrial structures, their combined and average volume, as well as the number of events at each frame in the time-lapse sequence can also be calculated. The results of this automatic analysis allow the quantitative assessment of fission, fusion and depolarisation localisation with high accuracy and precision.

The cell may be from a human or animal subject, or may be from a plant. More particularly, the cell may be in a cell-containing sample obtained from the human or animal subject. Alternatively, the cell sample can be from a cell line or animal model. The mitochondria in the cells can be stained to make them visible, e.g. by using a fluorescence probe that indicates the mitochondrial morphology and state of depolarisation. Tetramethylrhodamineethylester is one suitable example.

The method described herein has been termed the “mitochondrial event localiser (MEL)”, because it allows for the indication of the precise three-dimensional location at which fission, fusion and depolarisation are likely to occur next. Moreover, the method enables the determination of the individual locations of smaller structures that fuse to form a larger central structure in the two time-lapse frames that are considered. Similarly, the locations of smaller structures that will separate from a common central structure due to fission are identified. In doing so, the method provides a platform to better understand mitochondrial dynamics in the context of health and disease, with both screening and diagnostics potential. This approach is, as far as the applicant is aware, the first automated method for the detection of depolarised mitochondria in the context of fission and fusion events. The method can serve both as a standalone method or as part of a broader mitochondrial analysis pipeline to enable high-throughput analysis of time-lapse data.

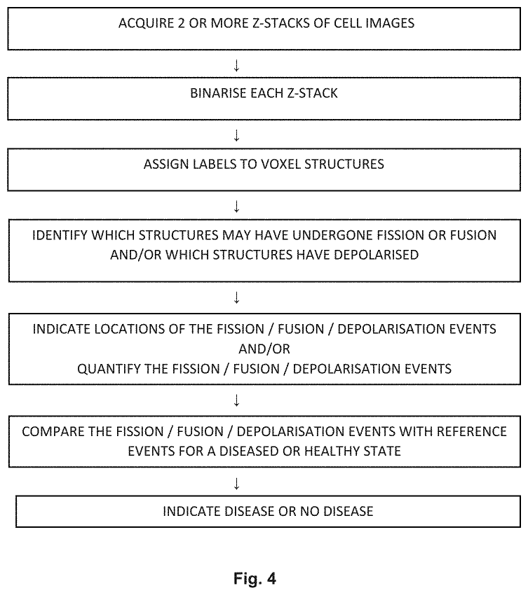

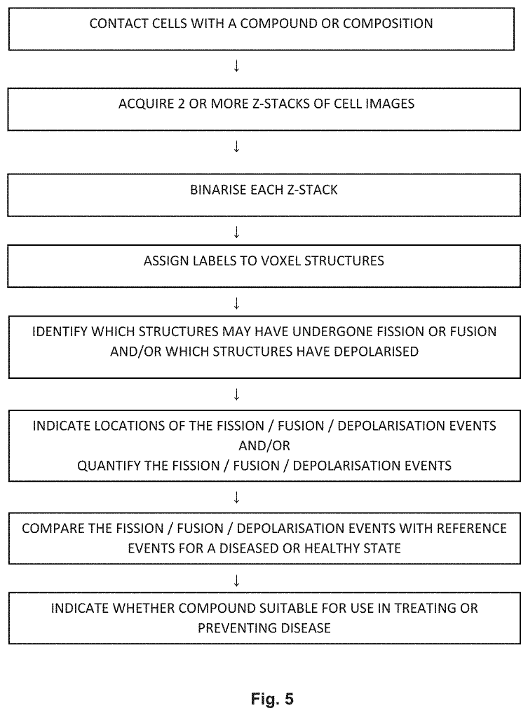

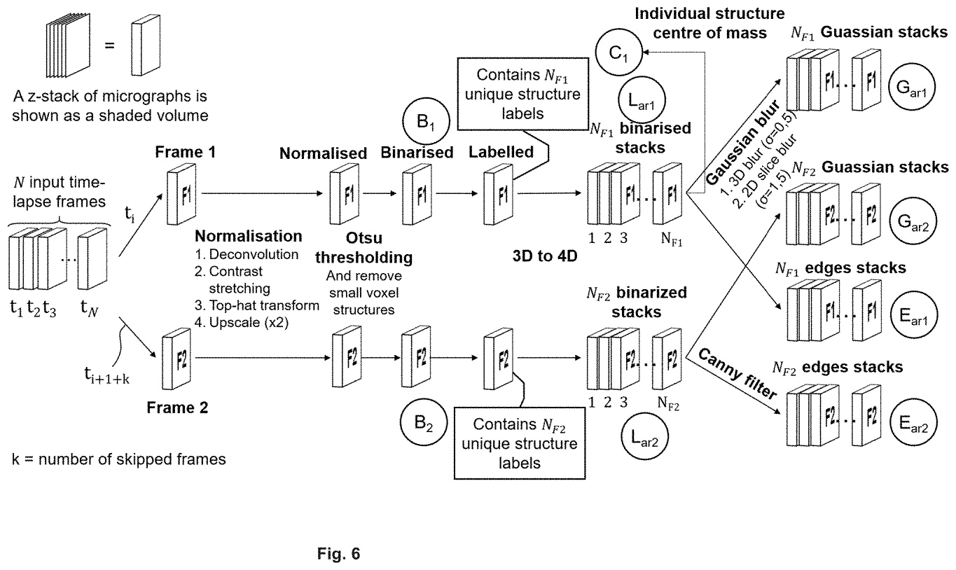

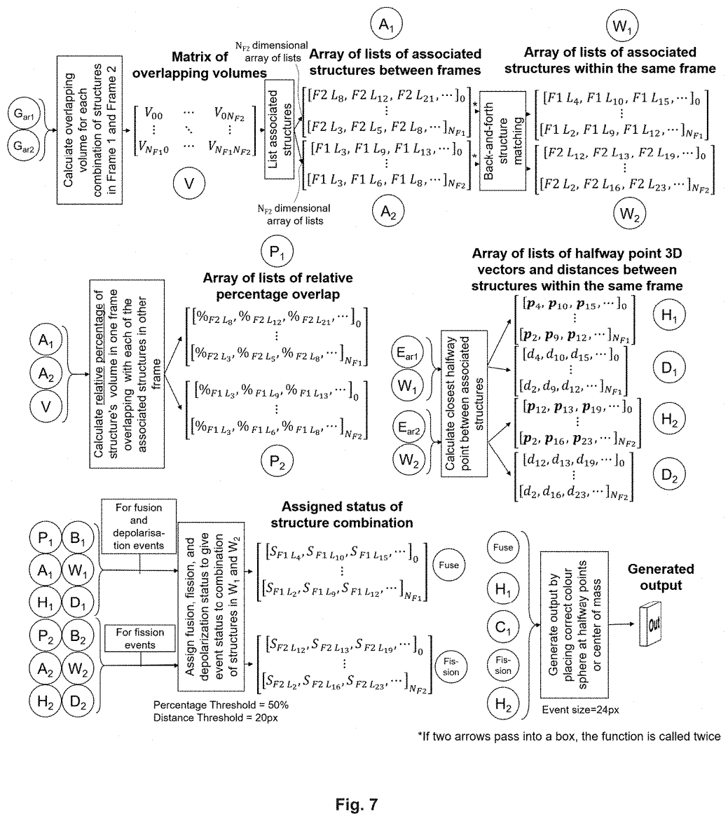

The method allows the assessment of whether a cellular system is in mitochondrial fission/fusion equilibrium and whether mitochondrial depolarisation events are kept within a physiological range. Where and when mitochondrial events, specifically fission, fusion and depolarisation, take place in the cell can also be visualised. The ratio between fission and fusion events can hence be indicated and is a quantitative metric of the equilibrium between fission and fusion (FIGS. 6 and 7 D). Given the regional complexity of cells, which may distinctively change in disease, with a particular distribution profile of organelles, mitochondria, ATP generation and vesicle dynamics associated with mitochondrial quality control, the method may be used to dissect localised regions of dysfunction or molecular defect precisely. Moreover, when applied in scenarios where particularly mitochondrial pathology is implicated, such as in neurodegeneration or mitophagy, precise mitochondrial event localisation as provided by the method may be of benefit. Due to the relatively simple data generation approach, a role for diagnostics, especially in the context of high-throughput imaging approaches using living cells, is also envisaged. Modern high-throughput imaging systems allow to control for temperature and CO₂ levels, therefore enabling to accurately record living cells in a statistically meaningful manner. In this manner, standards and databases can be created for fission/fusion equilibrium under control and/or diseased condition for candidate model systems. Currently, data on fission and fusion dynamics, where both the extent of fission and the extent of fusion is quantitatively captured, therefore allowing to describe whether the cell is in a fission/fusion equilibrium state, or changing towards either fusion or fission, does not exist. This will allow the diagnosis of diseases and conditions characterized by mitochondrial dysfunction (FIG. 4) and/or the screening of drugs that may impact mitochondrial health (FIG. 5), in the context of, for example, neurodegenerative diseases and cancer, where either mitochondrial dynamics are aimed to be maintained, preserved or improved (for neurodegenerative diseases), or effectively disrupted (cancer). This could be coupled to the detection of other critical parameters associated with cellular function, such as caspase activity, indicating the onset of apoptotic cell death. The method can also be used to exclude cell toxicity. Examples of neurodegenerative diseases include Parkinson's disease and Charcot-Marie-Tooth Type IIA disease, and typical cancers would be those where apoptotic cell death induction is the mode of choice in treatment intervention, such as gliomas and cervical cancer.

An algorithm for the method described herein can process a fluorescence microscopy time-lapse sequence of z-stack images that are stained for mitochondria and produce the 3D locations of the mitochondrial events occurring at each time step. These locations can subsequently be superimposed on the z-stacks in order to indicate the different mitochondrial events. The algorithm is organised into two consecutive steps—the image pre-processing step which normalises and prepares the time-lapse frames, and the automatic image analysis step which calculates the location of the mitochondrial events based on the normalised frames.

### Image Pre-Processing

The image pre-processing step receives a time-lapse sequence of z-stacks of images as input and begins by selecting two z-stacks (referred to below as Frame 1 and Frame 2) for further processing. Depending on the temporal resolution that is desired, the selected z-stacks can either be consecutive time-lapse frames, or some number k of intermediate frames may be skipped. The selected Frames 1 and 2 are then each processed in the same way by the image pre-processing step to generate several new image stacks (FIG. 6), which are passed to the automatic image analysis step. The stacks of Frame 1 and Frame 2 are differentiated in FIG. 6 by using subscripts 1 and 2, respectively. The image pre-processing step includes steps (i)-(vii) described above.

Since the method of the invention is not based on the analysis of a single cell, it is not necessary to select regions of interests (ROIs) before the analysis. However, since the image acquisition parameters that are used vary widely between different time-lapse sequences, the fluorescence intensity data of the z-stacks is first normalised. This is because the method relies on an accurate binarisation of the fluorescence image stack to identify voxels that contain mitochondria. These thresholding algorithms require images to be sharp, contain minimal noise, and have good contrast between the foreground and background.

The first step in normalising the raw micrographs is to apply deconvolution to the z-stacks using a point spread function (PSF) that is estimated from the microscope's acquisition parameters. Huygens Professional deconvolution software was used in the example described below (please provide the name and version of this software). Contrast stretching is then applied to the z-stack to normalise the fluorescence intensity between micrographs. The micrographs constituting the z-stack are then upscaled by a factor of two using bilinear interpolation so as to increase the resolution of the binarised image and reduce the possibility that two adjacent but unconnected structures are erroneously joined after binarisation. Finally, a three-dimensional top-hat transformation is applied to further reduce noise and enhance the mitochondria in such a way that they can be more easily isolated from the background.

In one embodiment, the normalised frames are binarised by applying Otsu thresholding to the z-stack, although other thresholding methods could also be used. Since noise remnants are also binarised, structures containing less than some appropriately small number of voxels in the upscaled images were removed (in the examples below, this number was 20, but a person skilled in the art will appreciate that a higher or lower number could be selected). The z-stack that results from this is labelled B in FIG. 6.

After binarisation, a label is assigned to each separate 3D voxel structure. The total number of labels in Frame 1 and Frame 2, as depicted in FIG. 6, are N_{F 1} and N_{F 2}, respectively. Later in the automatic image analysis step, each labelled structure in each frame will be compared with labelled structures both within the same frame as well as in the other frame. For this reason, the labelled z-stack is separated into an array of z-stacks, where the i^{th} stack in the array contains only the binarised voxel structure associated with label number i. This array of stacks is referred to as Lₐᵣ. The subscript “ar” is used to indicate an array of stacks, containing N_{F 1} and N_{F 2} stacks for Frame 1 and Frame 2, respectively. This step can be thought of as adding the structure label as a fourth dimension to the data and later enables fast comparison between different labelled structures.

From the array of labelled z-stacks Lₐᵣ, two similar arrays also required by the automatic image analysis step are created. The first is the result of applying a 3D Gaussian filter to each z-stack in the array. This slightly blurs the edges of the labelled stacks and results in the array of z-stacks Gₐᵣ. The Gaussian blurring enhances the ability of the algorithm to match the moving mitochondrial structures between two frames by slightly inflating the structures. The second array of stacks is generated by removing all voxels that are not located on the edges of the 3D labelled structures in Lₐᵣ by using Canny edge detection. The resulting array of z-stacks is referred to herein as Eₐᵣ. This is performed mainly to improve the efficiency of the algorithm that later determines the location of fission and fusion events.

This concludes the image pre-processing step. Tuneable (i.e. variable) parameters in this step are the volume of the structures that are considered as noise, and the standard deviation with which the z-stacks are Gaussian blurred. The z-stack B and the arrays of z-stacks Gₐᵣ and Eₐᵣ are passed into the automatic image analysis step that calculates the location of the mitochondrial events.

### Automatic Image Analysis Step

The automatic image analysis step generates a list of locations in Frame 1 at which the mitochondrial events occur. It achieves this by receiving the z-stacks that were generated in the image pre-processing step. These are then automatically analysed to produce a list of the mitochondrial event locations. The automatic image analysis step is shown in FIG. 7 and includes steps (viii)-(xii) described above.

The three different mitochondrial events that are considered herein, namely fission, fusion and depolarisation, are defined in terms of changes in mitochondrial morphology that occur in the time interval between Frames 1 and 2. Specifically, fission is defined as the separation of a larger mitochondrial structure to two smaller structures. Similarly, fusion is defined as the joining of two mitochondrial structures to form a single larger structure. Finally, depolarisation is defined as the disappearance of a mitochondrial structure from Frame 1 to Frame 2 manifested by a complete loss of fluorescence signal. If more than two structures fuse to a single central structure, or if one structure undergoes fission to form more than two smaller structures, then separate locations are assigned to each.

In order to determine the location of mitochondrial events, candidates for fission and fusion are identified from the voxel structures labelled during the image pre-processing step. First, the voxel structures in Frame 1 that occupy the same space as a voxel structures in Frame 2, and vice versa, are identified. For the sake of conciseness, such colocation of structures between the two frames are referred to as overlap. Using this overlap information, the voxel structures which are associated with each other within the same frame can be determined. In Frame 1, these associated structures are the fusion candidates, and in Frame 2 they are the fission candidates. Structures in Frame 1 that have no associated structures in Frame 2 undergo depolarisation.

In one embodiment, to determine the associated structures between Frame 1 and Frame 2, a matrix V is calculated containing the overlapping volume (in voxels) of each structure in Frame 1 with each structure in Frame 2 using the blurred arrays of z-stacks Gₐᵣ₁ and Gₐᵣ₂. Label number 0 is reserved for the background. Blurred stacks are used in order to allow for movement of the mitochondria between frames. Using matrix V, two arrays A₁ and A₂ are calculated. Each entry in array A₁ is a list of all the structures in Frame 2 that overlap with a particular structure in Frame 1. Similarly, A₂ indicates the structures in Frame 1 that overlap with a particular structure in Frame 2.

In one embodiment, an algorithm (referred to herein as back-and-forth structure matching) can be used to determine from the information in A₁ and A₂ which structures in Frame 1 are fusion candidates, and which structures in Frame 2 are fission candidates. For each structure in Frame 1, A₁ is used to determine all associated structures in Frame 2. For each of these associated structures in Frame 2, A₂ is used to determine all the associated structures in Frame 1.

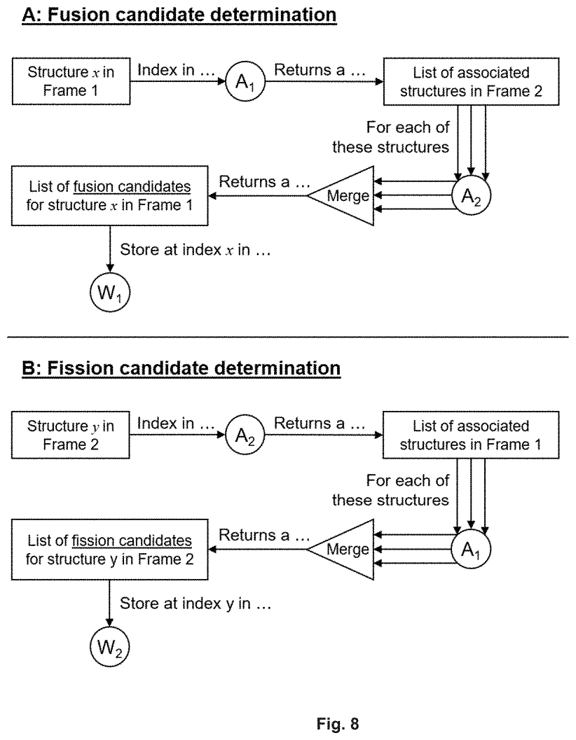

This list of Frame 1 structures comprises the fusion candidates for the Frame 1 structure being considered. An identical but opposite procedure is used to determine the fission candidates in Frame 2. The resulting two arrays of lists are denoted W₁ and W₂. A determination is then made as to which of these candidates actually underwent the mitochondrial event. The back-and-forth structure matching algorithm is illustrated in FIG. 8 and is practically demonstrated by way of synthetic example 2 described below.

Many of the mitochondrial event candidates identified in the previous step could be a result of coincidental structure overlap. These overlaps could either be due to mitochondrial movement in the time interval between Frame 1 and Frame 2, or as a result of comparing the blurred frames Gₐᵣ₁ and Gₐᵣ₂. Blurring was introduced to compensate for mitochondrial movement, but has the consequence of increasing the number of false overlaps. These coincidental overlaps can be removed as follows: Firstly, by calculating the relative percentage overlap between associated structures in Frame 1 and Frame 2. For each structure in Frame 1, the set of associated structures in Frame 2 is identified using A₁. Then, using V, the overlapping volume of each of these associated structures is normalised relative to the combined overlapping volume of all the associated structures. This results in the relative percentage overlap that each structure in Frame 2 has with the structure in Frame 1. In this way, structures with a small percentage overlap can be considered coincidental and ignored as candidates when determining the type of mitochondrial event. These overlap percentages are stored in an array of lists P₁, which has the same structure as A₁. An analogous procedure is followed for all the structures in Frame 2, in this case using A₂, resulting in P₂. P₁ and P₂ are used to remove mitochondrial event candidates whose proportion of volume overlap is small.

The back-and-forth structure matching algorithm can also produce false matches. For example, when two small structures are on opposite sides of a larger central structure in Frame 1 and both fuse with this central structure in Frame 2, the smaller structures in Frame 1 will be identified as being associated with each other. This is, however, a false match since no mitochondrial event occurs between them. Such false matches can easily be avoided by detecting the presence of a third mitochondrial structure between the two candidates for association, or by determining that the candidate structures are too far apart for a mitochondrial event to be feasible.

The shortest vector length as well as the point in 3D space midway between all structure pairs identified in W₁ and W₂ are therefore calculated. This midway point represents a likely location of fission and fusion events. The shortest vector lengths can be computed from the information in Eₐᵣ₁ and Eₐᵣ₂. The resulting list of shortest distances are denoted by D₁ and D₂ and the midway points by M₁ and M₂ for fusion and fission respectively. Note that the length of each array in the lists matches those of W₁ and W₂ for the same subscript.

Using A₁ and A₂, the structures in Frame 1 that have no associated structures in Frame 2 (indicating that they will depolarise) can be found. Next, the false fission and fusion candidate structures in W₁ and W₂ can be filtered out by using D₁, D₂, M₁ and M₂ to determine the final sets of fission and fusion events. First, a distance threshold corresponding to the maximum distance that a mitochondrial structure could be expected to move is determined. Then, all candidates in W₁ and W₂ for which the respective distances in D₁ and D₂ exceed this threshold are removed. Next, fission and fusion candidates separated by a third structure are removed by considering the binarised stacks B₁ and B₂ in conjunction with the midway points in M₁ and M₂. Finally, by using P₁, two structures within Frame 1 that are both associated with the same structure in Frame 2 with a high relative percentage overlap are considered as a fusion event. Similarly, using P₂, two structures within Frame 2 that are both associated with the same structure in Frame 1 with a high relative percentage overlap are considered as a fission event. Any structure pairs with a low and high, or a low and low, combination of relative percentage overlap is ignored. Empirically, it was observed that in most cases the relative percentage overlap is either above 90% or below 10%. Therefore, any percentage above 50% is considered to be high. This step results in two more arrays of lists. The Fusion array indicates which structures in Frame 1 will fuse, depolarise, or undergo no event. The Fission array indicates which structures in Frame 2 are the result of a fission event.

The final step is to generate an output image by superimposing a label (typically a colour label), in three-dimensional space, on the z-stack to indicate the location of each mitochondrial event at the midway point between the two structures that fuse in Frame 1, or using the midway point between the two structures that are the result of fission in Frame 2 as the location at which a structure in Frame 1 will undergo fission. The structures that will depolarise are indicated by placing a label at its centre of mass, which is calculated from the z-stack for the structure in question from the Lₐᵣ₁ array.

One example of the automatic image analysis step, indicating which stacks and list of arrays are used for which parts of the algorithm, is shown in FIG. 7. Tuneable (i.e. variable) parameters in this step are the volume overlap threshold, the percentage that is the threshold between a low and high relative overlap percentages and the distance threshold between structures that can be considered to be related to each other. In order to further clarify each step in the method of the invention, a synthetic sample is described below in Example 2.

Another embodiment of the invention is to perform the method of the invention without a time-lapse sequence. Neural networks can be trained to estimate the mitochondrial event locations from a single z-stack, for example by using several generated input-output pairs as ground truth data for neural network training. It is envisaged that conditional generative adversarial networks, such as the pix2pix network, could be used for this purpose.

Another embodiment of the invention is a computer-implemented method of using the method to locate and quantify mitochondrial events, to screen for drugs and exclude cell toxicity, to diagnose a disease or condition, and/or to determine the progression of a disease or condition. Other embodiments include a computer storage medium configured to store instructions to perform the computer-implemented method, and a computer system including a computer processor configured to perform the computer-implemented method.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

The invention will now be described in more detail by way of the following non-limiting examples.

### Example 1—Mammalian Cell Model

Using a mammalian cell model, the method of the invention was applied and validated by assessing the mitochondrial network under both physiological and disrupted conditions. Two control cells were analysed and these were contrasted with cells treated with hydroxychloroquine sulphate (HCQ), leading to mitochondrial dysfunction.

### Cell Line Maintenance

U-118MG cells were purchased from the American Type Culture Collection (ATCC), supplemented with Dulbecco's Modified Eagles Medium (DMEM), 1% penicillin/streptomycin (PenStrep) (Life Technologies, 41965062 and 15140122) and 10% foetal bovine serum (FBS) (Scientific Group, BC/50615-HI), and incubated in a humidified incubator (SL SHEL LAB CO₂ Humidified Incubator) in the presence of 5% CO₂ at 37° C.

### Microscopy

Live cell confocal microscopy of mitochondrial fission and fusion events was conducted using a Carl Zeiss Confocal Elyra S1 microscope with LSM 780 technology. Prior to imaging, U-118MG cells were seeded in Nunc® Lab-Tek® II 8 chamber dishes and incubated with 800 nM tetramethylrhodamine-ethyl ester to allow for the visualisation of the mitochondrial network (TMRE, Sigma Aldrich, 87917) for 30 minutes in the presence of 5% CO₂ at 37° C. In order to perturb the mitochondrial network, cells were exposed to 1 mM hydroxychloroquine sulphate (HCQ) (Life Technologies, T669). HCQ results in fragmentation of the mitochondrial network by disrupting electron transport chain efficiency.

For the two control samples, the time intervals between frames were 6 s and 20 s, respectively. For the HCQ treated samples, the time interval was 61.7 s.

### Visualising the Confidence of Mitochondrial Events

The accuracy of the results that can be affected by image quality. Therefore, to compensate for the variable image quality of the biological samples, the position of all mitochondrial events was calculated for three different contrast stretching parameters in the pre-processing phase. This leads to three output images, each with markers indicating the location of all mitochondrial events. The output images were then divided into non-overlapping 10-by-10-by-2 voxel blocks (x, y and z-axes respectively).

Within each block, the number of times each type of mitochondrial event was detected was counted for the three different pre-processing parameters. The different types of mitochondrial events were then visualised using different colour labels, where the intensity of these labels is proportional to the relative frequency with which each type of mitochondrial event was detected within each 10-by-10-by-2 voxel block. The intensity therefore serves as an indication of the confidence that the mitochondrial event is occurring at that location.

### Tunable Parameters

The pre-processing parameters and percentage and distance thresholds, which are used to remove false matches, are summarised in Table 1. These parameters were selected based on empirical observation. Alternatively, an automated statistical method could also be employed to determine the parameters based on the z-stack under analysis.

TABLE 1
The tuneable parameters used by MEL, and
the values used for experimentation.

| Tuneable parameter | Value |
|---|---|
| Noise volume | 20 voxels |
| Gaussian blur (x-y) | σ = 1.5 |
| Gaussian blur (z) | σ = 0.5 |
| Volume overlap threshold | σ = 1% |
| Relative percentage threshold | 50% |
| Distance threshold | 20 px |

### Results

The method of the invention was applied to four different time-lapse sequences of mammalian cells.

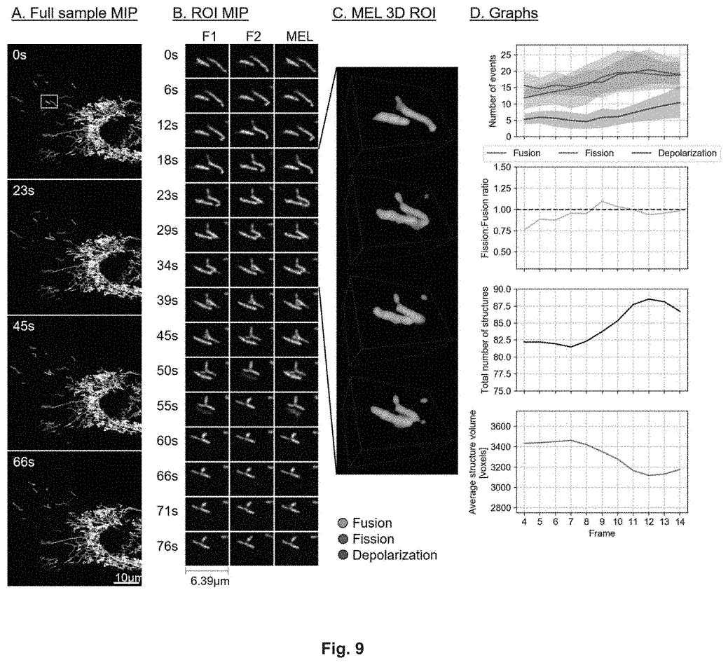

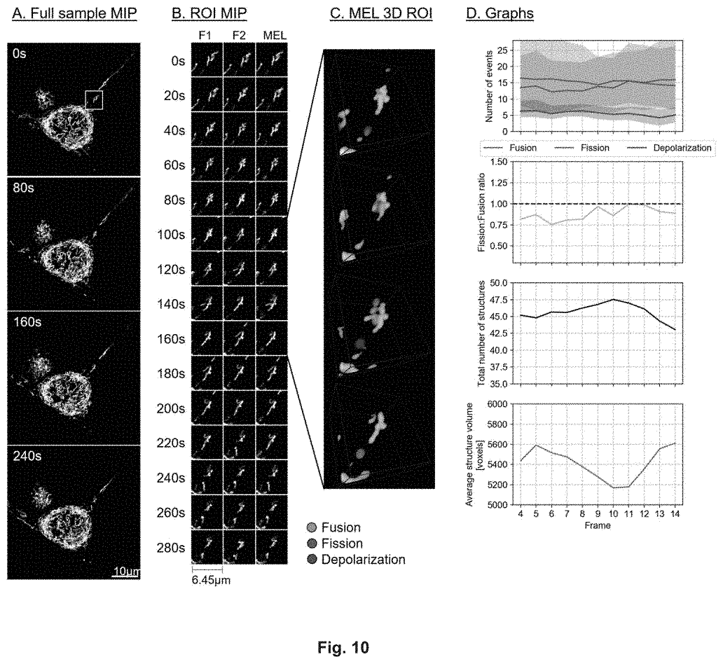

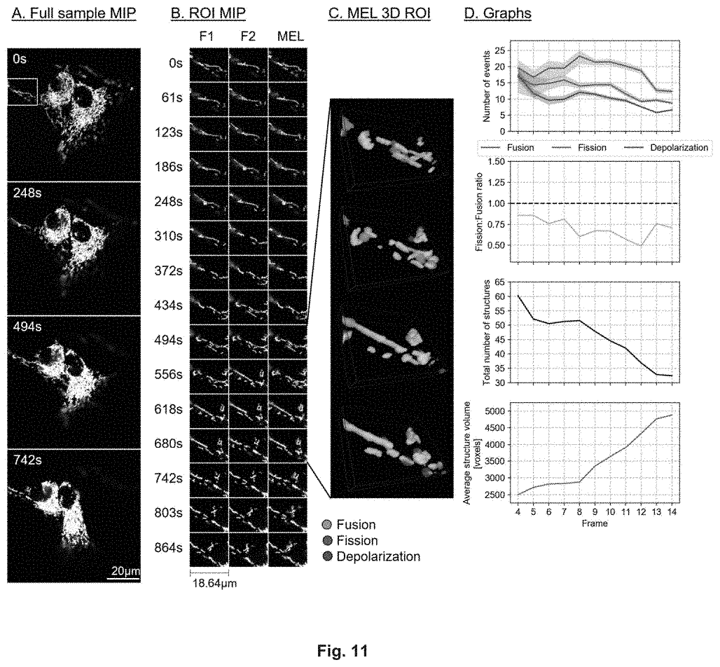

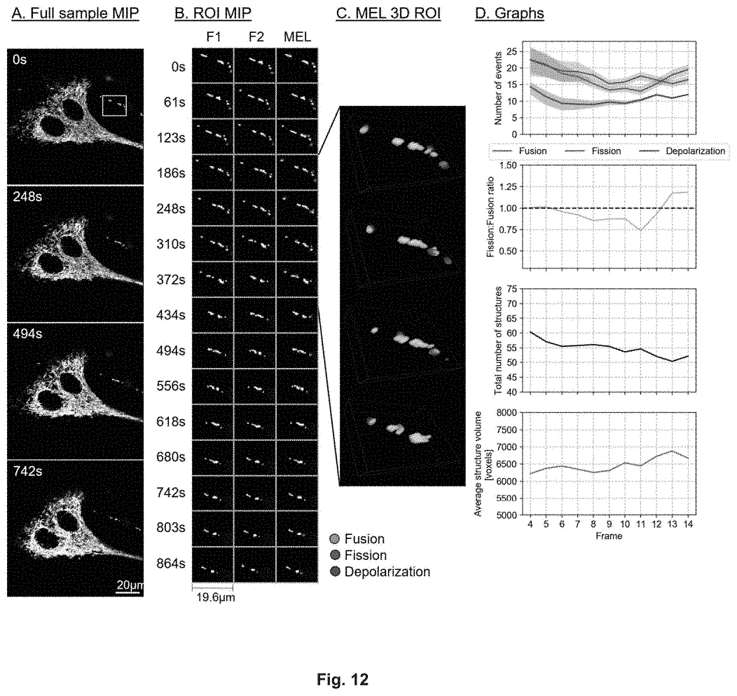

FIGS. 9 and 10 demonstrate the application of the method to two control time-lapse sequences of cells under physiological conditions and FIGS. 11 and 12 consider the application of the method to two cells that were treated with HCQ. The control cells were acquired with relatively short time intervals between the image frames, allowing individual mitochondrial structures to be more easily matched between consecutive frames, while the treated cells were acquired with larger time intervals between the image frames. This was done to validate the ability of the method to detect mitochondrial events in conditions characterised by decreased spatio-temporal resolution.

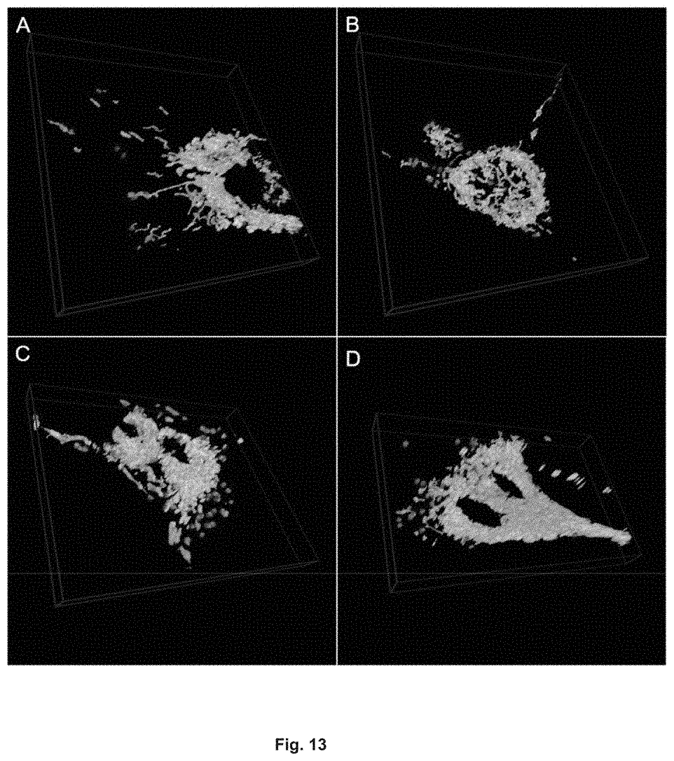

FIGS. 9-12A show the maximum intensity projection (MIP) of the output for every fourth frame in the time-lapse sequence. Column B shows the MIP of a region of interest (ROI), indicated by a white square in column A, for all the frames in the time-lapse sequence. The ROI was specifically chosen to highlight the detection and visualisation of mitochondrial events. This column shows both Frame 1 and Frame 2 that was used as well as the generated output frame. Column C shows a selection of the ROI frames in three dimensions. Column D shows a graphical summary of some of the data extracted by the method for each frame pair. This includes the five-frame simple moving average (SMA) of the number of mitochondrial events that occur, the fission/fusion ratio, the total number of mitochondrial structures, as well as the average volume of these structures. Lastly, FIG. 13 shows the 3D visualisation of the four cells with the mitochondrial event locations overlaid on the mitochondrial network. All sample visualisation and ROI selection was accomplished using a virtual reality based biological sample processing system (Theart R P et al. BMC Bioinformatics. 2017 February; 18(2):64; Theart R P et al. PloS one. 2018 Aug. 29; 13(8):e0201965). Visualisation of the distribution of mitochondrial events throughout the sample in virtual reality provides an unambiguous interpretation of the location of the events within the complex mitochondrial network.

Finally, the average percentage of structures that will undergo fission, fusion and depolarisation in every fourth frame in the time-lapse sequence (shown in column A of FIGS. 4-7) was calculated, and the results are summarised in Table 2.

TABLE 2
Mitochondrial event percentages for two control samples
and two cells treated with HCQ at four different time
points corresponding to column A in FIGS. 4-7.

| | | | Average total | | | Depolar- |
|---|---|---|---|---|---|---|
| | Time | | structures | Fusion % | Fission % | isation % |
| Control 1 | 0 | s | 80.67 | 21.1% | 12.8% | 3.3% |
| | 23 | s | 83.33 | 18.8% | 11.2% | 6.4% |
| | 45 | s | 87.00 | 25.7% | 20.7% | 3.1% |
| | 66 | s | 83.00 | 18.5% | 20.1% | 10.8% |
| Control 2 | 0 | s | 49.00 | 41.5% | 17.0% | 8.8% |
| | 80 | s | 45.67 | 32.8% | 27.7% | 12.4% |
| | 160 | s | 47.00 | 21.3% | 33.3% | 17.0% |
| | 240 | s | 43.00 | 42.6% | 23.3% | 10.1% |
| HCQ 1 | 0 | s | 94.33 | 33.9% | 26.9% | 43.1% |
| | 248 | s | 47.67 | 46.9% | 25.9% | 12.6% |
| | 494 | s | 50.00 | 70.7% | 10.7% | 36.0% |
| | 742 | s | 32.67 | 32.7% | 12.2% | 17.3% |
| HCQ 2 | 0 | s | 71.67 | 24.2% | 34.0% | 35.3% |
| | 248 | s | 55.33 | 48.2% | 30.7% | 12.7% |
| | 494 | s | 57.00 | 39.8% | 14.0% | 21.1% |
| | 742 | s | 48.67 | 53.4% | 53.4% | 37.0% |

### Example 2: Synthetically Generated Images

The steps of the method are demonstrated herein by applying the method to two synthetically generated image frames. This is intended only to clarify the MEL algorithm, and does not represent a realistic scenario as would be expected when analysing mitochondrial events. Although the method is intended for application to three-dimensional samples, two-dimensional images only are considered here for clarity.

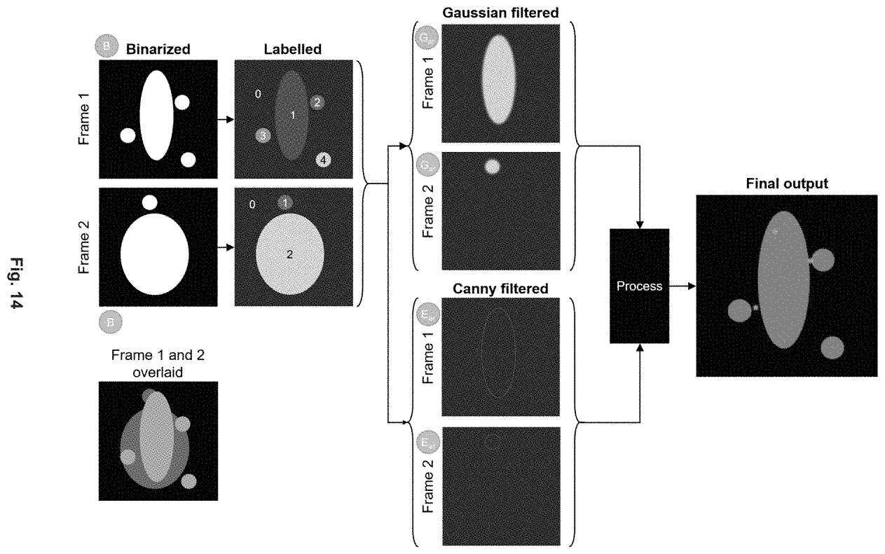

Since the images are synthetic, the normalisation step shown in FIG. 6 is omitted. FIG. 14 shows binarised Frames 1 and 2. These binarised images are overlaid to make it easier to identify those structures that will fuse or undergo fission from Frame 1 to Frame 2. Next, each structure in the binarised frames is given a unique label number, with 0 indicating the background. Each labelled structure is then separated to create an array of images (not shown) which is Gaussian filtered to allow for a less strict structure overlap matching between Frame 1 and Frame 2. The array of labelled images is also Canny filtered, leaving only the pixels on the edge which are used to determine the distance between structures and the location of the fission and fusion events. FIG. 14 shows only the first labelled structure in the array for each frame. These images are then analysed according to the process shown in FIG. 7 to produce a set of locations and types of mitochondrial events that are hypothesised to have occurred in the time between Frame 1 and Frame 2. The result is then overlaid with Frame 1 using labels for the different events.

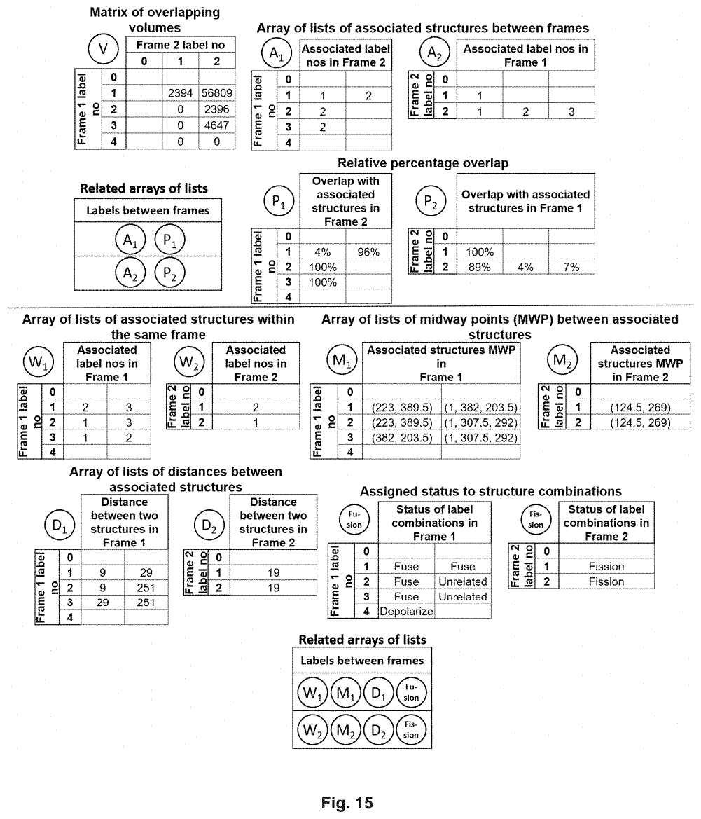

The matrices and arrays calculated for the synthetic example by the process depicted in FIG. 7 are shown in FIG. 15. The overlap matrix V is calculated by multiplying all combinations of the Gaussian filtered structures, one from Frame 1 and one from Frame 2, to determine a representation of the volume. Label number 0 indicates the background and therefore is left blank throughout.

In this example, there is a small overlap between Frame 1 label 4 and Frame 2 label 2 due to the blur which the filter has introduced. To compensate for such coincidental matches, all overlapping volumes that account for less than 1% of the volume of either structure in question are eliminated, and are consequently shown as 0 (FIG. 15).

From matrix V, the arrays A₁ and A₂ are determined by simply reducing V to indicate which structures in the other frame presented with a non-zero overlapping volume. The relative percentage overlap, P₁ and P₂, of each structure in one frame with all associated structures in the other frame can then be calculated from A₁ and A₂. This is in effect a normalisation of the volumes in matrix V, where the volume of a certain structure combination is divided by the total volume of the given structure in either Frame 1 (producing P₁) or Frame 2 (producing P₂). Each row, therefore, sums to 100%.

Using the back-and-forth structure matching described in FIG. 8, W₁ and W₂ are generated, to indicate which structures are associated with each other in the same frame. These are candidates for fission and fusion events, although some of them could be false matches that the next step aims to eliminate. It is worth noting that each structure combination occurs twice in the array of lists. Even though the calculations that follow are shown for both, it is only necessary to use one.

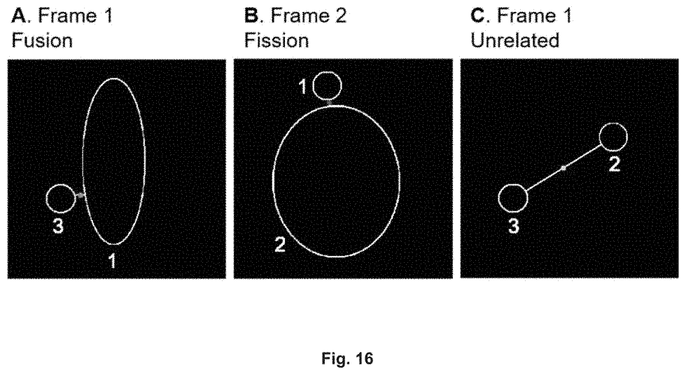

Using W₁ and W₂ along with the edge array of images Eₐᵣ for Frame 1 and Frame 2, the shortest distances, D₁ and D₂, as well as the midway points, M₁ and M₂, are found between each combination of structures. If the shortest distance between the candidate structures is above a set threshold (in the case of this synthetic example this was 50 pixels), the two structures are considered unrelated and is ignored in the visualisation (FIGS. 14 and 16). If the midway point is sampled from the binarised images, B₁ and B₂, and coincides with another structure it is also considered a false match. This is because two structures cannot fuse through a third separating structure. Rather, they would individually fuse with the central structure. A similar logic applies when considering fission events in Frame 2. This is illustrated in FIG. 16 for a fusion, fission and unrelated label combination.

Now the mitochondrial event status can be determined for each candidate structure combination in W₁ and W₂. Structures in Frame 1 are labelled “Fuse”, “Depolarize” or “Unrelated”, while structures in Frame 2 are labelled “Fission” or “Unrelated”.

Finally, using the midway points, as well as the centre of mass of the structures to indicate the location of the mitochondrial event, along with the status arrays, the final output image is generated (FIG. 10).

### Discussion

Data extracted by applying the method of the invention, as shown in column D in FIGS. 9-12 and Table 2, reveal that the control cells are characterised by the maintenance of a fission/fusion equilibrium, with limited occurrence of depolarisation events throughout the time-lapse sequence. This is commonly expected for healthy cells. In contrast, HCQ treated cells exhibit much greater fluctuations in the fission/fusion equilibrium as well as a greater extent of depolarisation.

From a morphological point of view, a widely spread, highly interconnected mitochondrial network was observed for the control samples (column A in FIGS. 9 and 10). The peripheral cell regions are characterised by a loosely defined network morphology, with few denser structures that are localised more centrally. Both fission and fusion events localise in both central and peripheral regions, in what appears to be a random fashion, with no particular focus regions or hotspots of occurrence. In contrast, the HCQ-treated samples display a very different and distinct event profile for all mitochondrial events. Most notably, a strong occurrence of depolarisation was localised primarily in the peripheral regions, a pattern that is maintained throughout the time of acquisition (FIGS. 11 and 12). A bias toward fusion events was also seen as the network morphology becomes more densely networked, indicating mitochondrial injury. This results in fewer mitochondrial structures, each with a higher average volume. This is, to the applicant's knowledge, the first time that depolarisation events could be localised in this manner and precision, within the context of fission and fusion events.

In general, there is very little change in the overall mitochondrial network pattern of the control samples (column A in FIGS. 9 and 10), even when taking the shorter interval between samples into account. In comparison, the mitochondrial network of the HCQ-treated samples (column A in FIGS. 11 and 12) initially appears more loosely networked and, as time progresses, is seen to become denser and centred with swollen mitochondrial morphology. This accounts for the decrease in the mitochondrial events, as well as the more consistent results for different pre-processing parameters in later frames of the time-lapse sequence.

### Fission and Fusion Events

Most of the fission and fusion events were observed in the periphery and distal regions of the mitochondrial network, with very few events detected in the strongly networked areas.

Using FIGS. 9B and C as an example, it was often observed that the same structures alternate between fission and fusion events (between 23-50 s), with possible eventual depolarisation of one of the structures (55s).

### Depolarisation Events

To the applicant's knowledge, this method is the first approach that allows the automatic localisation of depolarisation events. This is specifically significant as depolarisation of the entire mitochondrial network has been associated with caspase-3 activation, the execution of apoptotic cell death and generally demarcates the point of no return (PONR) for apoptosis. Therefore, the method of the invention may be of particular value in the quantitative assessment of cell death onset, associated with a wide range of diseases such as neurodegenerative disease, cancer or ischaemic heart disease.

Depolarisation was observed to be most abundant in the HCQ treated samples, with the majority of the depolarisation events localised in mitochondria that become isolated from the main mitochondrial network and have a small average volume. This was usually observed to occur in the cell periphery (column A in FIGS. 11 and 12).

The above description has been presented for the purpose of illustration, and is not intended to be exhaustive or to limit the invention to the precise forms disclosed. Persons skilled in the relevant art can appreciate that many modifications and variations are possible in light of the above disclosure.

1. A method of determining mitochondrial fission, fusion and/or depolarisation events in a cell, the method comprising the steps of:
i) acquiring at least two fluorescence-based z-stacks of images of the same cells, wherein the mitochondria are visible in the images and there is a time interval between the acquisition of the first and second z-stacks of images;
ii) binarising the two z-stacks of images to form a binarised z-stack for the first z-stack of images and a binarised z-stack for the second z-stack of images, wherein the mitochondria in the binarised z-stacks are represented by voxel structures;
iii) assigning labels to the voxel structures in the two binarised z-stacks; and
iv) identifying which of the labelled voxel structures may have undergone fission or fusion and/or had depolarised in the interval between the acquisition of the first z-stack of images and the acquisition of the second z-stack of images.

2. The method of claim 1, which comprises the further step of:
v) determining which of the voxel structures identified in step (iv) had undergone fission or fusion in the interval between the acquisition of the first z-stack of images and the acquisition of the second z-stack of images by filtering out false fission and fusion structure pairs.

3. The method of claim 1, which comprises the further step of:
vi) indicating the locations of the fission, fusion and/or depolarisation events identified in steps (iv) and/or (v) within the cells.

4. The method of claim 1, which comprises the further step of:
vii) generating a count of the number of mitochondrial fission, fusion and depolarisation events; and optionally
viii) comparing the number and/or location of the fission, fusion and/or depolarisation events with predetermined reference mitochondrial fission, fusion and/or depolarisation events of a healthy state or a diseased state associated with an increase or decrease in mitochondrial fission, fusion and/or depolarisation events; and
ix) outputting a diagnosis of a disease or disorder associated with an increase or decrease in mitochondrial fission, fusion and/or depolarisation events.

5. The method of claim 1, wherein the fluorescence intensity of the two z-stacks of images is normalised between steps (i) and (ii).

6. The method of claim 1, wherein between steps (iii) and (iv), each of the labelled structures are separated into an array of z-stacks for each of the binarised z-stacks, where each z-stack in each of the arrays contains only one labelled voxel structure.

7. The method of claim 6, wherein a 3D Gaussian filter is applied to each z-stack in the first array to create a second array of z-stacks for each of the binarised z-stacks.

8. The method of claim 1, wherein voxels not located on the edges of the labelled voxel structures in the first arrays of z-stacks are removed to create a third array of z-stacks for each of the binarised z-stacks.

9. The method of claim 2, wherein the voxel structures which may have undergone fission or fusion are determined in step (iv) by:
a) identifying voxel structures which overlap between the binarised first z-stack of images and the binarised second z-stack of images;
b) using the information obtained in step (a) to determine, for each z-stack of images, which structures are associated with other structures within the same z-stack of images;
c) identifying the structures that are associated with each other in the first z-stack of images as structures that are likely to undergo fusion; and
d) identifying the structures that are associated with each other in the second z-stack of images as structures that are likely to undergo fission.

10. The method of claim 9, wherein:
step (a) is performed by calculating the overlapping volume of each voxel structure in the binarised first z-stack of images and each structure in the binarised second z-stack of images;
in step (b), the information from step (a) is used to identify labelled structures in the second z-stack of images that are associated with labelled structures in the first z-stack of images and thereby to identify structures that are associated with each other in the first z-stack of images; and to identify labelled structures in the first z-stack of images that are associated with labelled structures in the second z-stack of images, thereby to identify structures that are associated with each other in the second z-stack of images;
the identification in step (iv) of the voxel structures that had undergone depolarisation is performed by determining that a labelled voxel structure in the binarised z-stack for the first z-stack of images does not have an associated labelled voxel structure in the binarised z-stack for the second z-stack of images; and/or
the filtering out of false fission and fusion structure pairs in step (v) is performed by:
e) calculating at least one of the following:
the relative percentage of overlap for the associated structures between the binarised first and second z-stacks of images that were identified in step (a);
midway points between the associated structures within the same z-stacks of images that were identified in steps (b) and (c); and/or
distances between the associated structures within the same z-stacks of images that were identified in steps (b) and (c); and
f) removing associated structure pairs for which the relative percentage of overlap is below a predetermined threshold, where the distance between the associated structures is greater than a predetermined threshold, and/or where the midway point between the structures contains a mitochondrial structure in the first binarised z-stack.

11-13. (canceled)

14. The method of claim 3, wherein the locations of the fission, fusion and/or depolarisation events within the cell are indicated in step (vi) by generating an output z-stack of images which shows the location of the fission, fusion and/or depolarisation events that occurred in the interval between the acquisition of the first z-stack of images and the acquisition of the second z-stack of images.

15. The method of claim 1, wherein the time interval between the acquisition of the first z-stack of images and the acquisition of the second z-stack of images is in the range of from about is to about 90 s, optionally from about 5 s to about 60 s.

16. (canceled)

17. The method of claim 1, wherein the images are micrographs.

18. The method of claim 1, wherein the cell has been stained for mitochondria prior to acquisition of the z-stacks of images.

19. (canceled)

20. The method of claim 1, which comprises the steps of:
i) acquiring at least two fluorescence-based z-stacks of images of the same cells, wherein the mitochondria are visible in the images and there is a time interval between the acquisition of the first and second z-stacks of images;
ia) normalising the fluorescence intensity of the two z-stacks of images;
ii) binarising the two normalised z-stacks of images to form a binarised z-stack for the first z-stack of images (B₁) and a binarised z-stack for the second z-stack of images (B₂), wherein the mitochondria in the binarised z-stacks are represented by voxel structures;
iii) assigning labels to the voxel structures in the two binarised z-stacks;
iiia) separating each of the labelled structures into a first array of z-stacks (Lₐᵣ) for each of the binarised z-stacks, where each z-stack in each of the arrays contains only one labelled voxel structure;
iiib) applying a 3D Gaussian filter to each z-stack in the first array (Lₐᵣ) to create a second array of z-stacks (Gₐᵣ) for each of the binarised z-stacks;
iiic) removing voxels not located on the edges of the labelled voxel structures in the first arrays of z-stacks (Lₐᵣ) to create a third array of z-stacks (Eₐᵣ) for each of the binarised z-stacks;
iv) identifying which of the labelled voxel structures may have undergone fission or fusion and/or had depolarised in the interval between the acquisition of the first z-stack of images and the acquisition of the second z-stack of images;
v) determining which of the voxel structures identified in step (iv) had undergone fission or fusion in the interval between the acquisition of the first z-stack of images and the acquisition of the second z-stack of images by filtering out false fission and fusion structure pairs;
vi) indicating the locations of the fission, fusion and/or depolarisation events identified in steps (iv) and (v) within the cells; and
vii) generating a count of the number of mitochondrial fission, fusion and/or depolarisation events.

21. A method of diagnosing a disease or disorder which is associated with an increase or decrease in mitochondrial fission, fusion and/or depolarisation events relative to a healthy state, the method comprising the steps of:
i) determining the location and/or quantity of mitochondrial fission, fusion and/or depolarisation events according to claim 1; and
ii) comparing these events to predetermined reference mitochondrial fission, fusion and/or depolarisation events of a healthy or diseased state.

22. The method of claim 21, wherein the disease or disorder is selected from the group consisting of a neurodegenerative disease, cancer and ischaemic heart disease.

23. A method of screening a candidate compound or composition for use in the treatment or prevention of a disease or disorder which is associated with an increase or decrease in mitochondrial fission, fusion and/or depolarisation events relative to a healthy state, the method comprising the steps of:
i) contacting cells of a human or animal with the compound or composition;
ii) performing the method of claim 1 on at least one cell which has been contacted with the compound or composition to determine the localisation and/or quantity of mitochondrial fission, fusion and/or depolarisation events; and
iii) comparing the mitochondrial fission, fusion and/or depolarisation events determined in step (ii) with reference fission, fusion and depolarisation events of a healthy or diseased state.

24. The method of claim 1, wherein steps (ii)-(iv) are performed on a computer.

25-26. (canceled)

27. The method of claim 1, wherein the cell in the z-stacks of images of step
(i) has been contacted with a compound or composition prior to the images being obtained, and wherein the method further comprises the step of:
indicating whether the compound or composition is suitable for use in preventing or treating a disease or disorder associated with an increase or decrease in mitochondrial fission, fusion and/or depolarisation events.

28-33. (canceled)
